(19) United States
(12) Patent Application Publication
(10) Pub. No.: US 2013/0091010 A1
(43) Pub. Date: Apr. 11, 2013

(54) Audience and Performance Guarantees using a Statistical Model for Risk Assessment

(71) Applicants: Julian Baim, Montville, NJ (US); James Collins, New York, NY (US); Marty Frankel, Cos Cob, CT (US); Mickey Galin, New York, NY (US)

(72) Inventors: Julian Baim, Montville, NJ (US); James Collins, New York, NY (US); Marty Frankel, Cos Cob, CT (US); Mickey Galin, New York, NY (US)

(21) Appl. No.: 13/481,455

(22) Filed: May 25, 2012

Related U.S. Application Data
(60) Provisional application No. 61/544,157, filed on Oct. 6, 2011.

(51) Int. Cl. G06Q 30/02

(52) U.S. Cl. 705/14.43

(57) ABSTRACT

A risk management system enables users to assess various probabilities of achieving certain audience and advertising delivery guarantees by computing levels of risk associated with various levels of audience guarantees. Statistical theory is applied to actual currency level audience estimation systems to support an application that implements a guarantee tool so that users may examine the specific risk levels for specific advertising schedules. In one illustrative example, both sellers and buyers of magazine advertising may utilize the risk management system to negotiate guarantees at specific ad-audience levels.

### STATEMENT OF RELATED APPLICATION

This application claims the benefit of provisional application No. 61/544,157, filed Oct. 6, 2011, which is incorporated by reference herein.

### BACKGROUND

Since 2005, magazines in the United States have been under increasing pressure to maintain revenue stream levels from advertising and from circulation. This strain has its root causes in the intensely competitive and burgeoning media landscape and, more importantly, from the continuing demand from agencies and advertisers for timely measures of accountability and ROI (“return on investment”) from the print media. One of the critical issues affecting print's competitive standing vis-à-vis other media is publishers' use of circulation rate base guarantees, a virtually unique phenomenon of the United States print industry, as the basis to negotiate cost-per-thousand copies with advertisers. These circulation-based guarantees are substantially different from audience-based guarantees provided by other media and have been subjected to criticism for being anachronistic and, at times, misleading.

This Background is provided to introduce a brief context for the Summary and Detailed Description that follow. This Background is not intended to be an aid in determining the scope of the claimed subject matter nor be viewed as limiting the claimed subject matter to implementations that solve any or all of the disadvantages or problems presented above.

### SUMMARY

A risk management system enables users to assess various probabilities of achieving certain audience and advertising delivery guarantees by computing levels of risk associated with various levels of audience guarantees. Statistical theory is applied to actual currency level audience estimation systems to support an application that implements a guarantee tool so that users may examine the specific risk levels for specific advertising schedules. In one illustrative example, both sellers and buyers of magazine advertising may utilize the risk management system to negotiate guarantees at specific ad-audience levels.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### DESCRIPTION OF THE DRAWINGS

FIG. 1 shows an illustrative computing environment in which users of various computing platforms may connect over a network to a risk management system hosted by a service provider;

FIGS. 2-6 show various windows supported by an illustrative user interface to the web-based application supported by a risk management system which enables users to examine the specific risk levels for specific advertising schedules;

FIGS. 7 and 8 show illustrative distributions of ad noting scores for various publications;

FIGS. 9 and 10 show illustrative distributions of the sum of 5 ad noting audience levels for various publications;

FIG. 11 shows an illustrative distribution of the sum of multiple ads in multiple different magazines of the same category;

FIG. 12 shows an illustrative distribution of the sum of multiple ads in multiple different magazines of different categories;

FIGS. 13-17 show various illustrative single ad distributions; and

FIGS. 18-22 show various illustrative distributions of a gross audience of 5 ads.

### DETAILED DESCRIPTION

A number of prominent print media executives, representing buyers and sellers, have been vocal about the need to move to a more relevant guarantee metric, either at an issue-specific audience level or, at an even more accountable ad-specific audience/ad action taken level. While their viewpoint may not be universally shared, they have made compelling arguments for moving away from circulation-based metrics as the basis of guarantees. While several magazines have offered guarantees based on advertising impact, the question still remains—if so many key players see the need for change, why has movement been so slow in this area? One answer lies predominantly in the fear publishers have of relinquishing control of the rate-base metric to others using a different measure. As one commentator maintains “ . . . publishers can exercise a high level of control over their ultimate circulation levels. They can't exercise the same level of control in syndicated magazine audience measurement because of issues like sample variation, respondent memory, and the like.” (see Hanrahan, Jack “Magazine Circulation Guarantees: The Basics” Circ Matters Volume 4 Number 6: 2, 2011). In effect, the reluctance to shift metrics derives from an aversion to incur risk in a new system.

This issue of risk-reward is addressed by the present risk management system. Principles of Risk Management are incorporated into the system through the application of basic probability theory and methods. In an illustrative example, the risk management system enables an assessment of various probabilities of achieving certain audience and advertising delivery guarantees. “Risk Management” may be defined as the identification, assessment, and prioritization of risks (for example, as defined in ISO 31000, as the effect of uncertainty on objectives, whether positive or negative) followed by coordinated and economical application of resources to minimize, monitor, and control the probability and/or impact of unfortunate events or to maximize the realization of opportunities.

A theoretical development is now presented to demonstrate the statistical foundation and context underlying the present risk management system that utilizes a determination of probabilities associated with achieving audience and advertising delivery guarantees. A basic audience guarantee is defined as a scalar value (the guarantee level), and a set of magazine issues and delivery conditions within the issue(s). In the development that follows it is assumed that the scalar and magazine issue(s) delivery condition(s) are expressed as totals rather than intersections or some other more complex sub-conditions.

For example, an audience guarantee might be that a noting audience for a specific advertisement (“ad”) appearing on page 64 of the Jul. 2, 2011 issue of Magazine A will be 10 million adults, or the Jul. 11, 2011 audience of magazine B will be 20 million adults, or the gross number of adults noting ads on page 23 of the July 23 issue of magazine C or on page 35 of the August 3 issue of magazine D will be 25 million adults.

In order to describe and assess various probabilities associated with the basic audience guarantee, let X₁, X₂, . . . Xₙ denote random variables, one for each magazine issue and delivery condition audience. For example, suppose the guarantee involves the noting audience for a particular ad execution PG1 that appears in 2 issues of magazine A and 3 issues of magazine B and a different execution PG2 (for the same product) that runs in 2 different issues of magazine C. Then X₁ denotes the ad noting audience for the ad PG1 that appears in the first issue of magazine A; X₂ denotes the ad noting audience for the ad PG1 that appears in the second issue of magazine A; X₃ denotes the ad noting audience for the ad PG1 that appears in the first issue of magazine B, and so on to X₇ which denotes the ad noting audience for ad PG2 that appears in the second issue of magazine C. In this case there are 7 random variables, X₁ through X₇.

It is asserted, and shown below by empirical demonstration, that each of these random variables, X₁ through X₇ may be approximated by a normal distribution with mean μi and σi2. The normality of the distribution of Xᵢ follows from the central limit theorem applied to the estimated issue specific audience and ad noting score estimate. These are based on independent samples of size 2,500 and 125 respectively. While the product of two independent normal distributions follows a product-normal distribution, it is shown below that for this application the distribution may be approximated by a normal random variable.

It is noted that the true parameter associated with the guarantee will never be known with certainty because it is based on a sample estimate. However, since the satisfaction of the guarantee is based on this estimate, it will act as the relevant outcome parameter. This situation not only exists for print magazines, but for television and radio as well.

The basic theorem that allows for the assessment of probabilities associated with audience guarantees is that the sum of two independent standard normal random variables is normal with mean zero and variance two. Symbolically if X˜N(0, 1) and Y˜N(0, 1), then X+Y˜N(0, 2). This theorem may be extended to show that the sum of two independent normal random variables with any particular means and variances is itself normal. Stated in symbolic terms if

X˜N(μₐ, σₐ) and Y˜N(μ_{b}, σ_{b}) then it follows that

X+Y˜N(μ_{a+b}, {square root over (σₐ²+σ_{b}²))})

This result may be extended to include any linear combination of independent normal random variables as follows:

Let X₁, X₂, X₃ . . . Xₖ denote a vector of independently distributed normal random variables and let a₁, a₂, a₃ . . . aₖ denote a vector of scalar constants, then

Σᵢ₌₁^{k}aᵢXᵢ˜N(μ_{lc}, σ_{lc})

where

μ_{lc}=Σᵢ₌^{k}aᵢμᵢ

σ_{lc}=\sqrt{Σᵢ₌^{k}aᵢ²σᵢ²}

Using this result, the probability that the estimated gross audience for a specified set of ads running in a specified set of issues of magazines will fall within a set of specified bounds can be assessed. In particular, if S=(s₁, s₂, . . . sₖ), a particular schedule of ads running in various magazine issues, the probability that the defined audience will fall within limits t₁ and t₂ is given by:

$$P ( {t}_{1} < S < {t}_{2} ) = {\int }_{{t}_{1}}^{{t}_{2}} \frac{1}{2 \sqrt{π {σ}_{s}^{2}}} {e}^{- {[ ( S - {μ}_{s} ) ]}^{2} / 2 {σ}_{s}^{2}} d s$$

If μᵢ is defined as the mean of the distribution of the ith issue-ad distribution and σᵢ² as the corresponding variance of the issue-ad distribution, then

μₛ=μ₁+μ₂+ . . . +μₖ,

and

σₛ=\sqrt{Σᵢ₌^{k}σᵢ²}.

It is assumed that estimates of μᵢ and σᵢ² are available from prior actual data. Various procedures may be used when a sufficient number of prior values are not available, as discussed below.

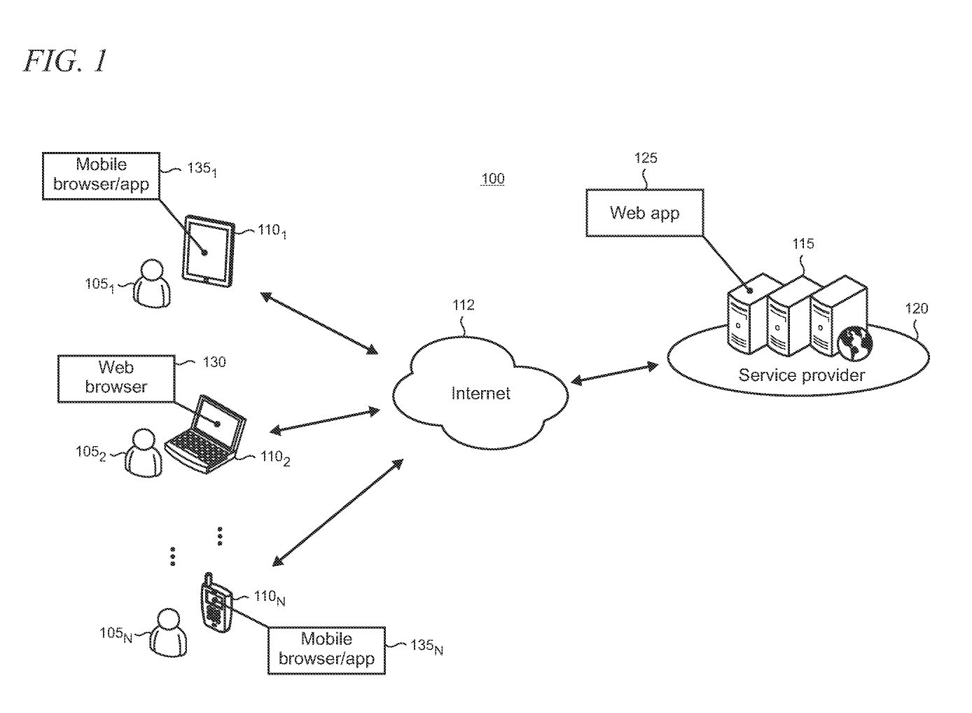

A description is now presented of an application which enables users to assess associated risk of various guarantee levels. Turning now to FIG. 1, shown is an illustrative computing environment 100 in which users 105 of various computing devices 110 may connect over a network, such as the Internet 112, to a risk management system 115 hosted by a service provider 120. The risk management system 115 supports an application that runs as a web-based application 125 in this illustrative example. Accordingly, code stored on the risk management system 115 is run, at least in part, locally on a client that is instantiated on respective computing devices 110. The client may be implemented, for example, as an Internet browser 130 or as a standalone application that runs on a personal computer, or as a mobile browser or other “app” (collectively identified by reference numeral 135) that runs on a mobile/smart phone or tablet computer.

The web-based application 125 is built using the statistical foundation discussed above and exposes a guarantee tool to the users 105. The overall goal of the guarantee tool is to provide the buyers and sellers of print with a capability for determining the number of gross ad impressions that would be guaranteed over the course of a particular ad campaign and to inform the buy/sell negotiations. Accordingly, the users 105 in FIG. 1 can represent either print buyers or sellers.

The guarantee is analogous to that given by publishing companies using circulation, but moves the commitment to a more ROI accountable metric. In addition to establishing a guaranteed number of ad impressions, the risk management system 115 informs a given user 105 of the risk incurred with an associated numerical guarantee. For example, a publisher might want to guarantee “x” number of gross ad impressions over the course of a campaign that includes a specified number of insertions from her stable of magazines. In this case, the risk management system 115 will report the attendant probabilities of success and risk of failure with the guarantee. The user 105 can then work within the risk management system 115 to assess the associated changes in risk and reward with different gross ad impression levels.

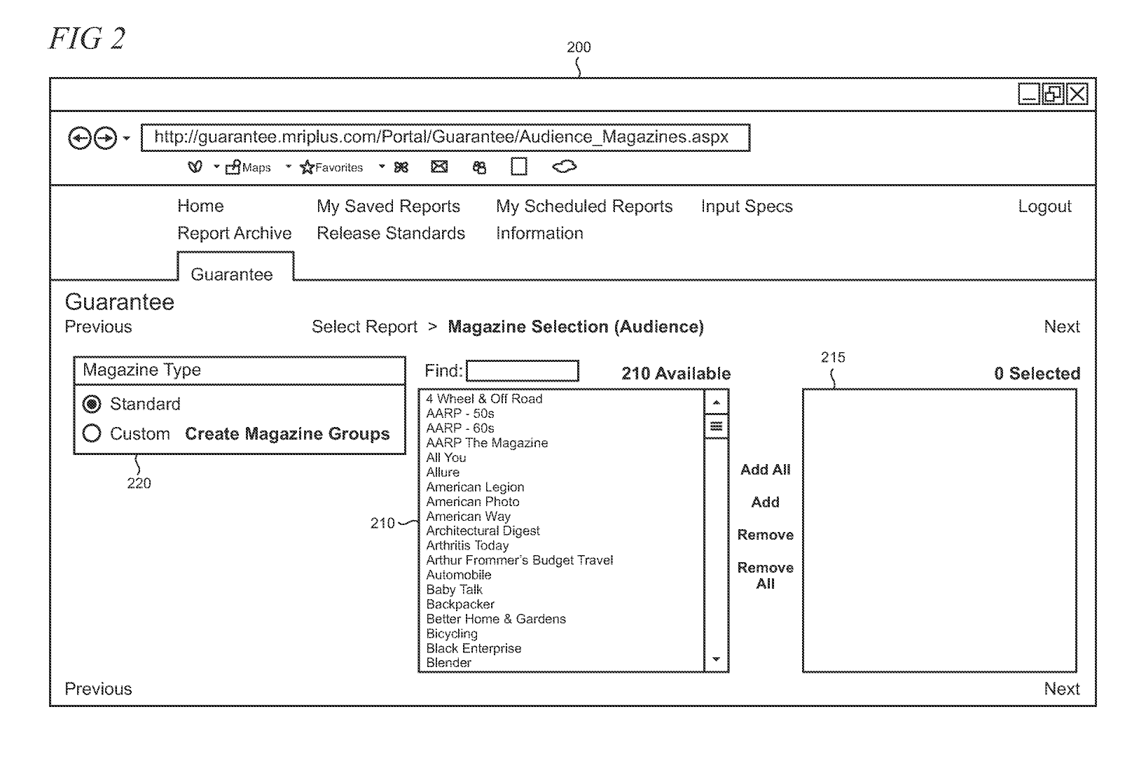

FIGS. 2-6 show various windows supported by an illustrative user interface to the guarantee tool supported by the web-based application 125. Window 200 in FIG. 2 shows a first stage of creating the guarantee in which the user 105 (FIG. 1) selects a list of magazines from the available publications measured in all three GfK Mediamark Research & Intelligence, LLC (“GfK MRI”) audience studies (i.e., the National Survey of the American Consumer Study, the Issue Specific Study, and the Starch Ad Measures Study). The magazine selection is accomplished, in this illustrative example, using a scrollable list 210 from which the user 105 may choose for inclusion in a selection window 215 by manipulating the appropriate controls shown in window 200. A user 105 can also create proprietary lists of competitive sets or a publisher's group of magazines that will be included in the overall guarantee by interacting with the controls in the magazine type box 220.

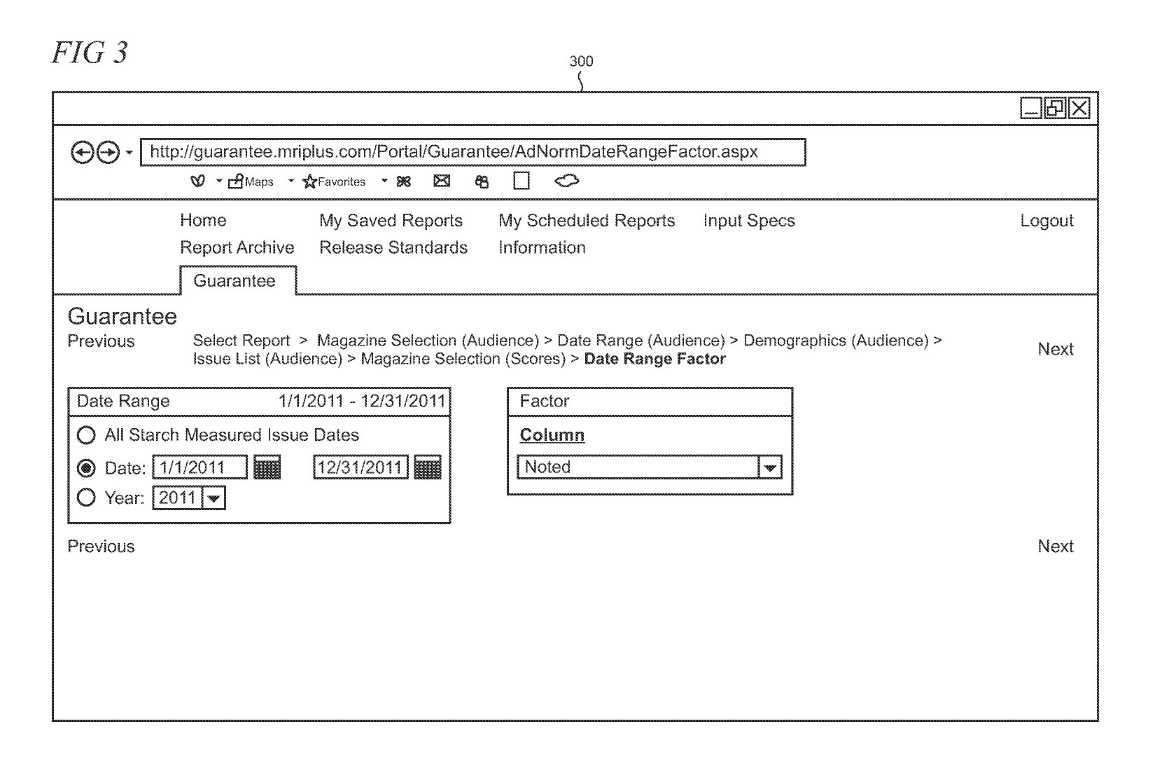

Window 300 in FIG. 3 shows the next stage in the guarantee process which enables the user 105 (FIG. 1) to select the time frame of historical data that will be part of the guarantee calculation. Since data are available from 2008 onward for most of the publications that are measured, the users 105 have the flexibility of basing their guarantee on the most recent set of data or on a longer period of time with many more instances of measured ads.

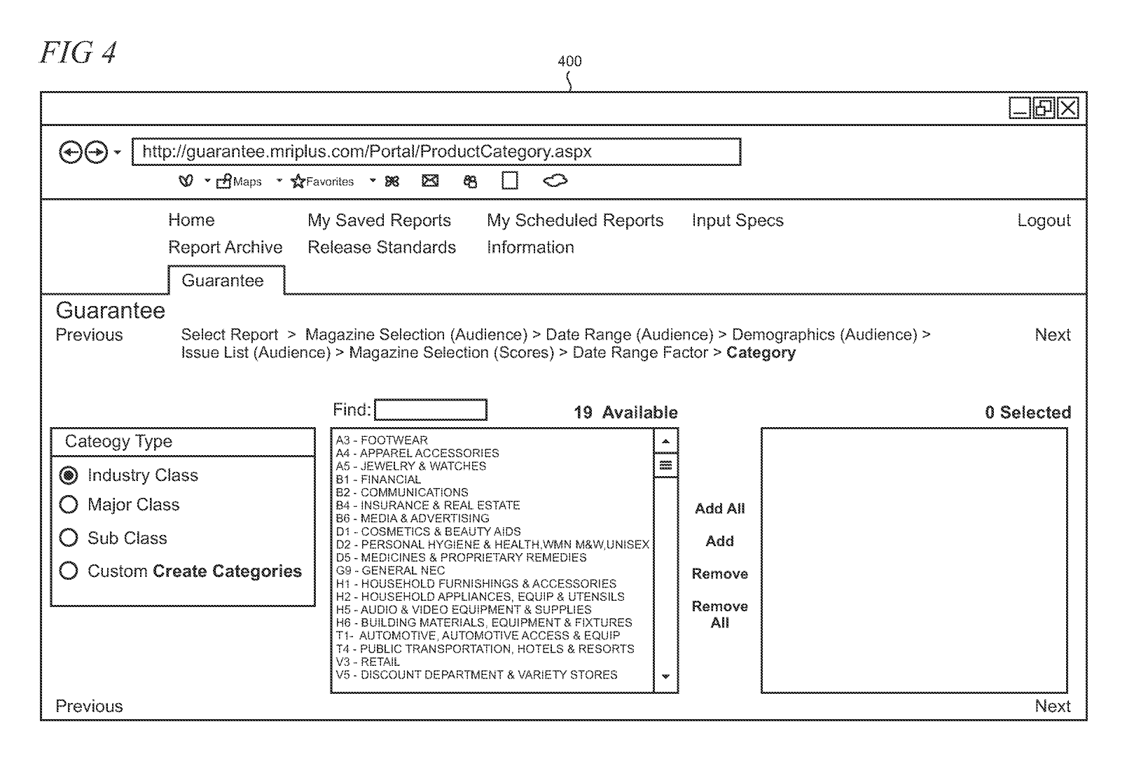

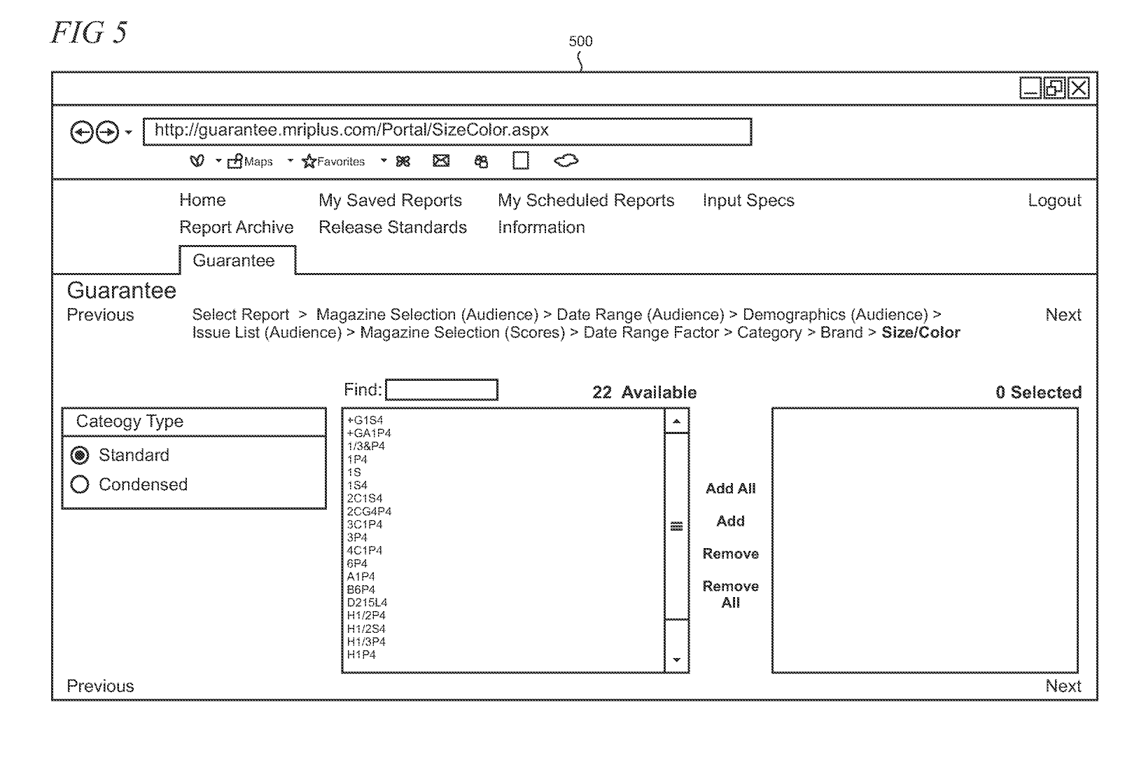

Window 400 in FIG. 4 shows that at the third stage of the guarantee process, the user 105 (FIG. 1) is enabled to search for the most appropriate set of ads that will serve as the statistical basis for developing the guarantee. If the campaign is specifically about a particular advertiser or advertising category, various options are available through the window 400 to restrict the historical data to only those ads that reflect the upcoming ad campaign. The risk management system 115 (FIG. 1) provides a warning if there are too few historical examples for establishing guarantees, thereby informing the user 105 to revise his selection of past performing ads to include a broader ad category. The user 105 may also have the option as shown in window 500 in FIG. 5, of selecting the type or size of ads (e.g., one-page, four-color) that will reflect the type of ads to be used in the upcoming campaign.

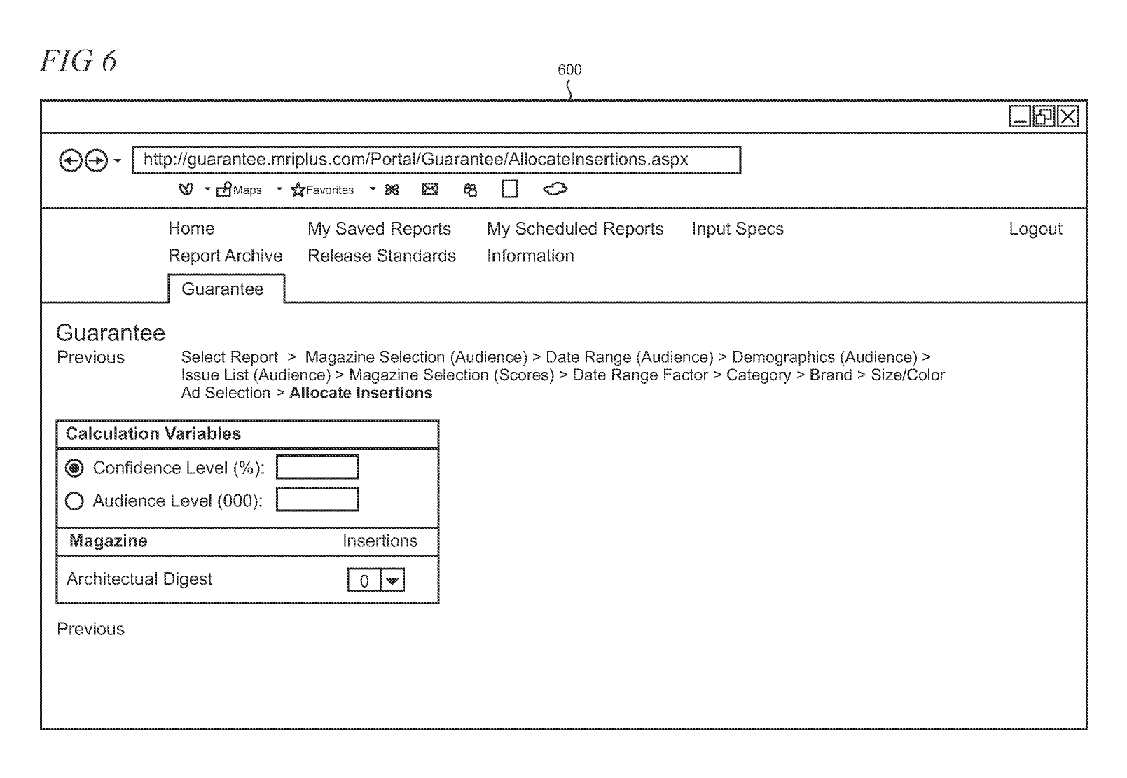

Window 600 in FIG. 6 illustrates the final stage implemented by the risk management system that affords the user 105 (FIG. 1) two options: (1) enter the level of risk the publisher is willing to incur for the guarantee and then the system 115 returns the number of gross ad impressions consistent with that risk or (2) enter the number of gross ad impressions the publisher is willing to guarantee for the ad campaign and then the risk management system 115 returns the level of risk associated with that number.

In either of these cases, the user 105 enters the number of insertions for each magazine, respectively, in the upcoming ad campaign. The risk management system 115 also enables the user 105 to vary the number of insertions and assess the corresponding change in guaranteed gross ad impressions.

Presented next is a discussion of an empirical validation of assumptions, distributions, and predicted results. As is the case with any theoretical development, the translation of theory into a practical application involves the satisfaction of certain assumptions. In order to test the degree to which these assumptions are satisfied and the degree with which the actual results agree with the predicted results, a number of simulations may be conducted involving actual noting audiences as measured by the GfK MRI ad measure system.

Three distributions are examined, all assumed to be normal with calculable means and variances, by the theory. These distributions are: (1) the distribution of a noting audience for a single ad in a single issue, (2) the distribution of the sum of noting audiences in ads across multiple issues of the same magazine title, or (3) the distribution of the sum of noting audiences across multiple ads in multiple issues of different titles.

In order to examine validity of these assumptions, the ad noting audience levels for selected categories are examined in 7 titles: Allure, Better Homes and Gardens, Conde Nast Traveler, Glamour, Lucky, Time, and Vogue. The ad categories are restricted as follows: (Time—Automotive, Conde Nast Traveler—Hotels & Resorts and Transportation, All other Titles—Cosmetics and Beauty Aids). These represent more than 3,000 specific issue-ad pairs.

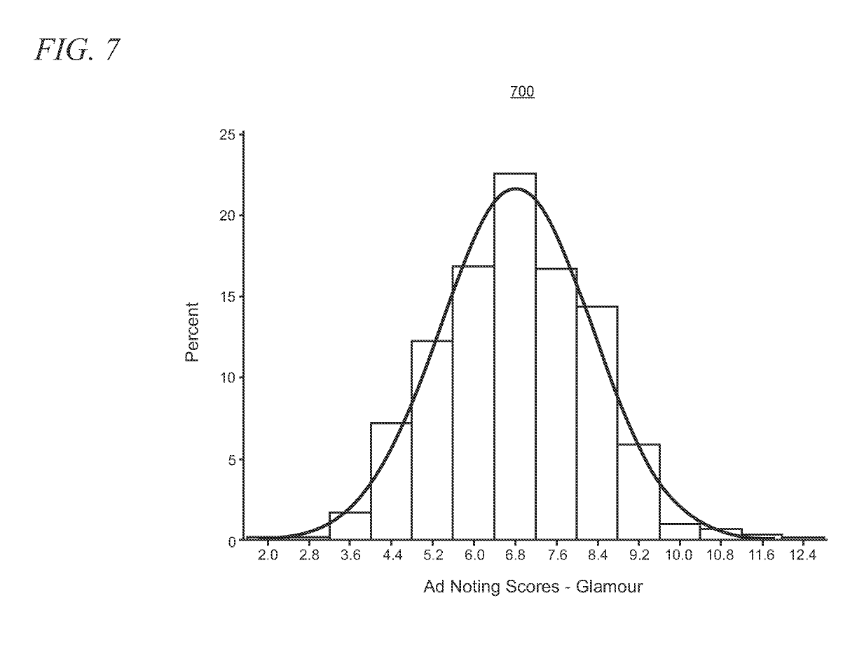

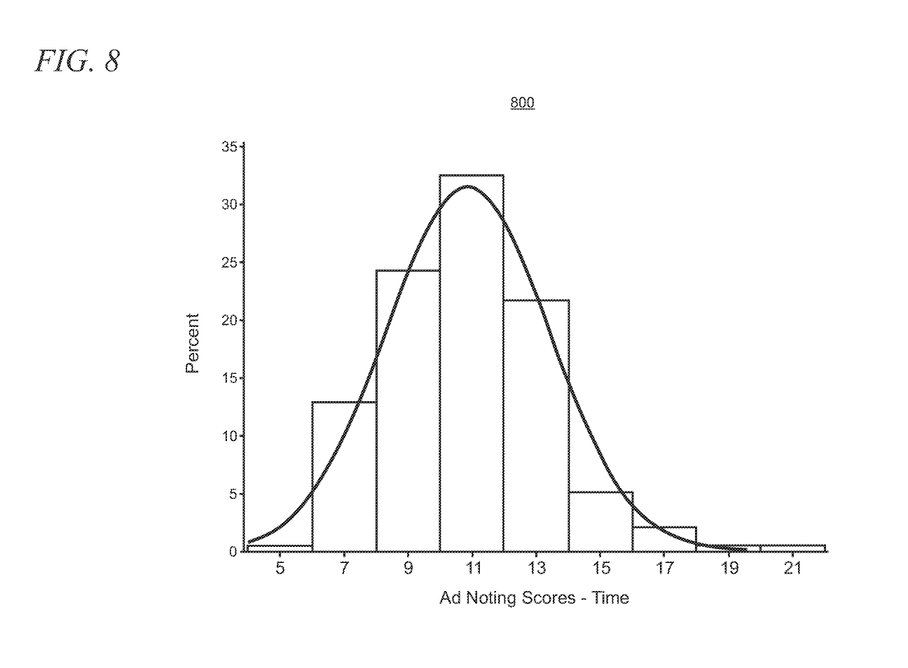

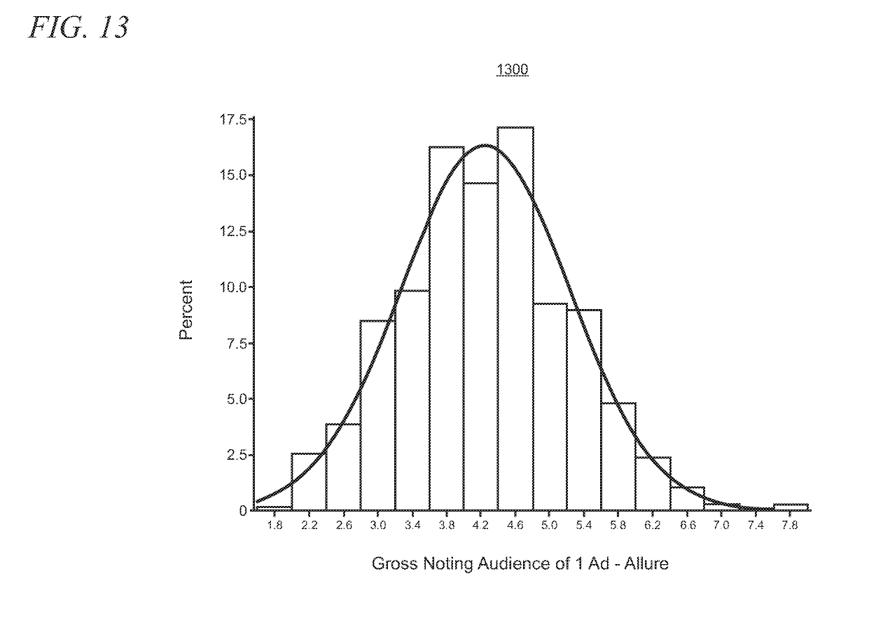

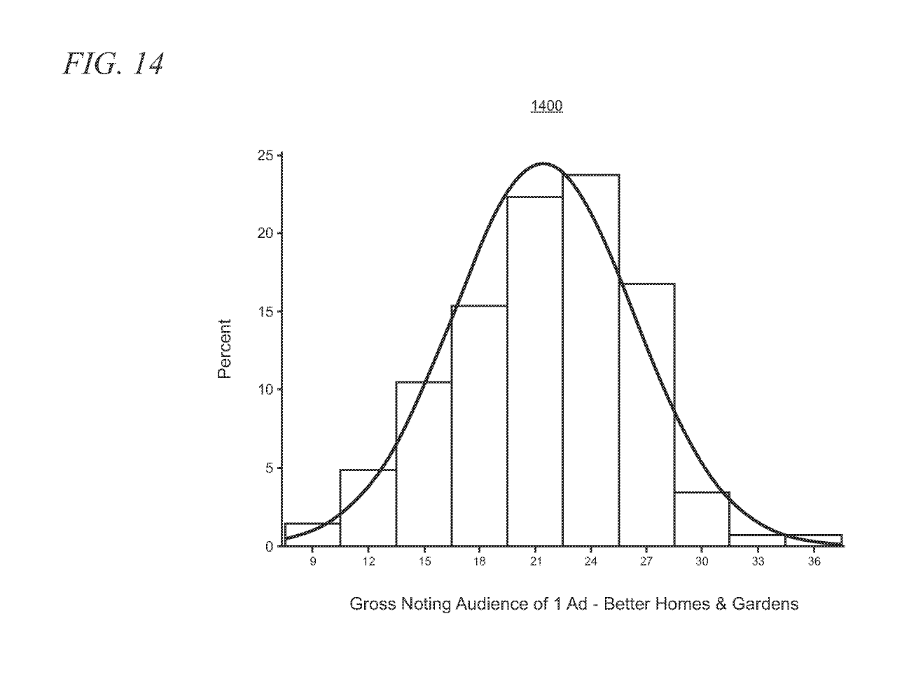

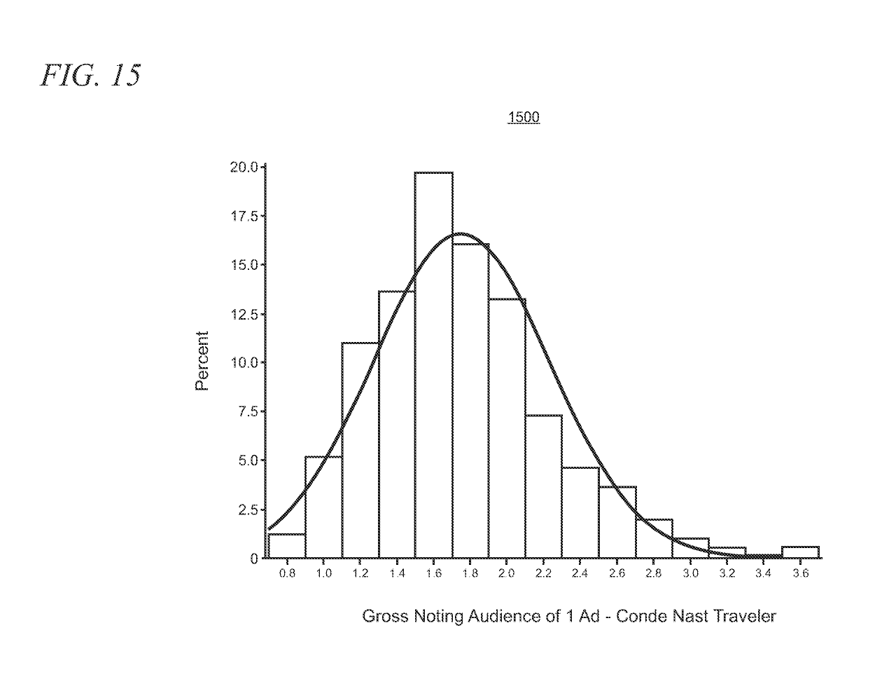

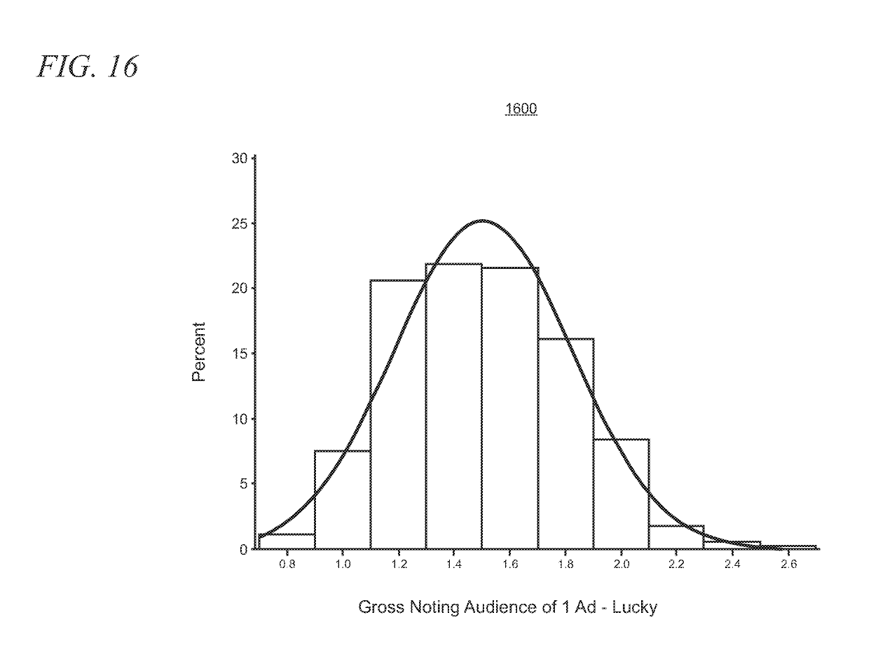

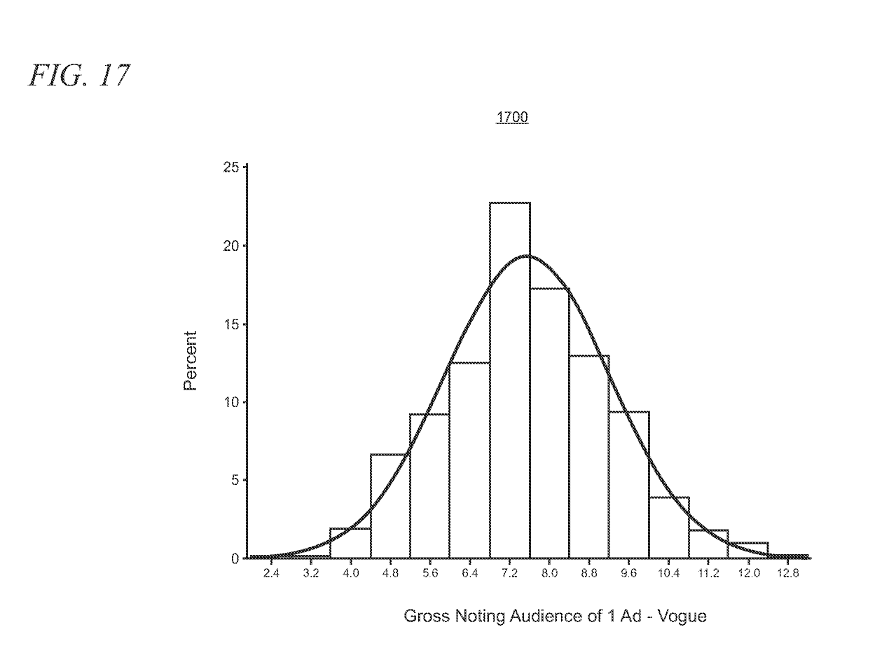

To examine the degree to which the audience levels for single ads follow the normal distribution, the actual ad noting score (i.e., audience levels) is graphed using histograms with the normal curve superimposed. The histograms 700, 800, 1300, 1400, 1500, 1600, and 1700 respectively shown in FIGS. 7-8 and 13-17 indicate that the noting scores are not perfectly consistent with the normal distribution but that the departures from normality are not severe. However, they do indicate that the use of the normal distribution to produce statements of risk for guarantees based on single ads in single issues should be viewed as approximations.

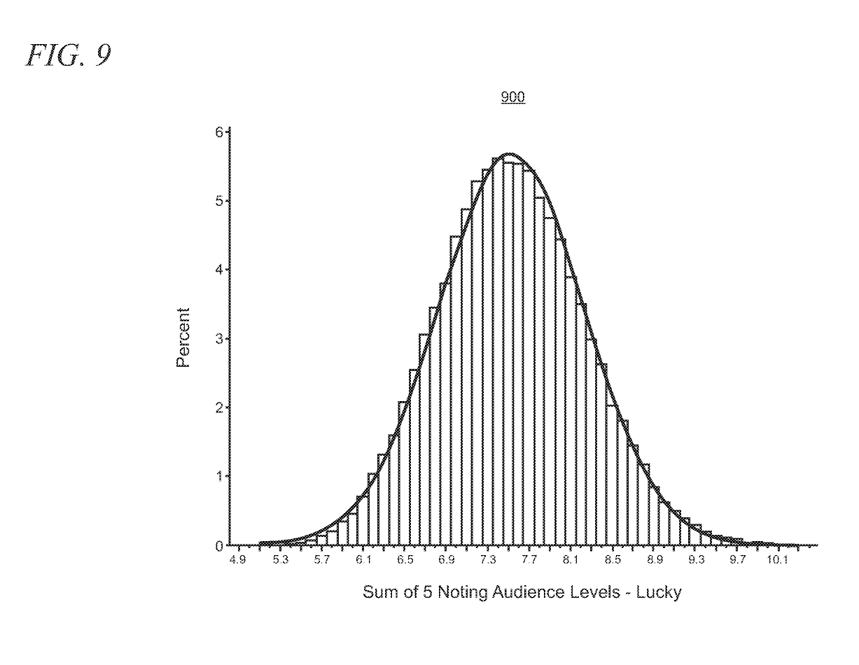

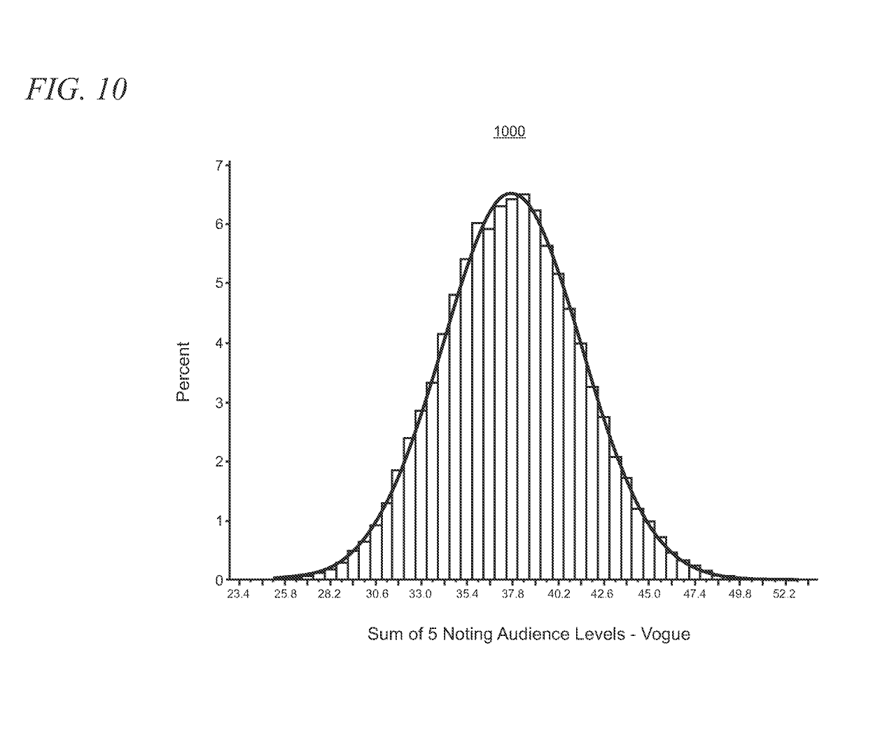

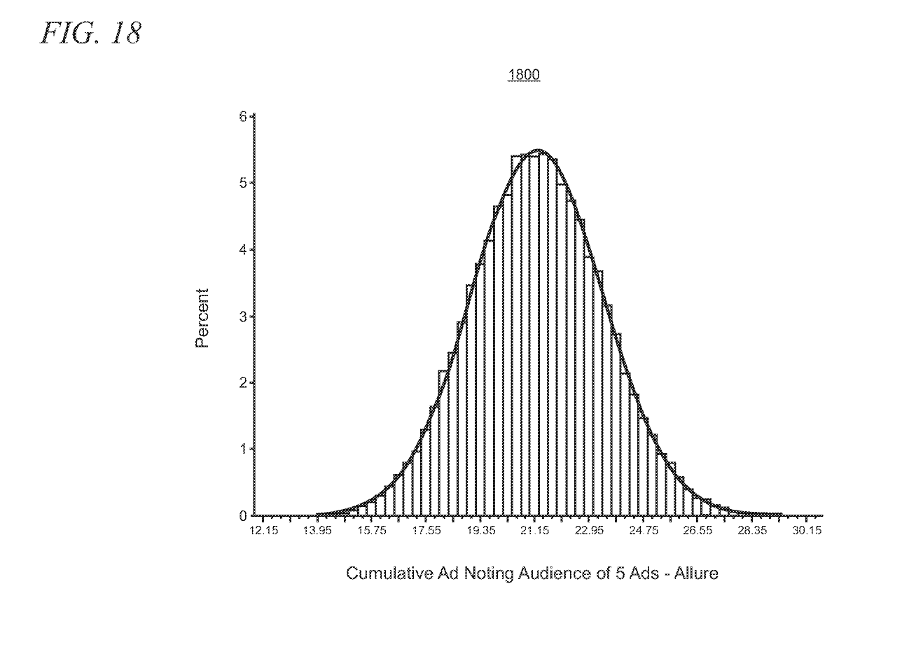

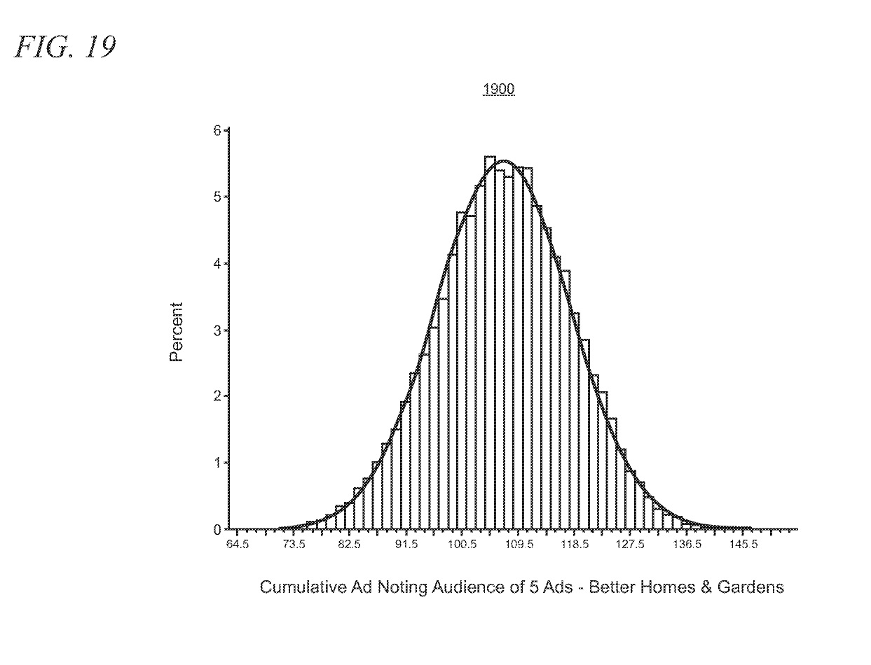

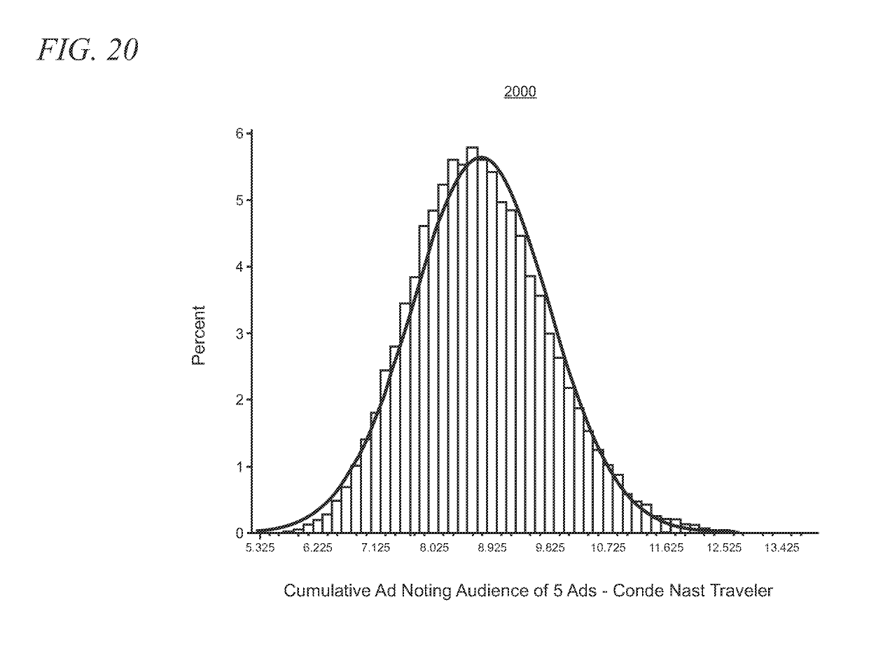

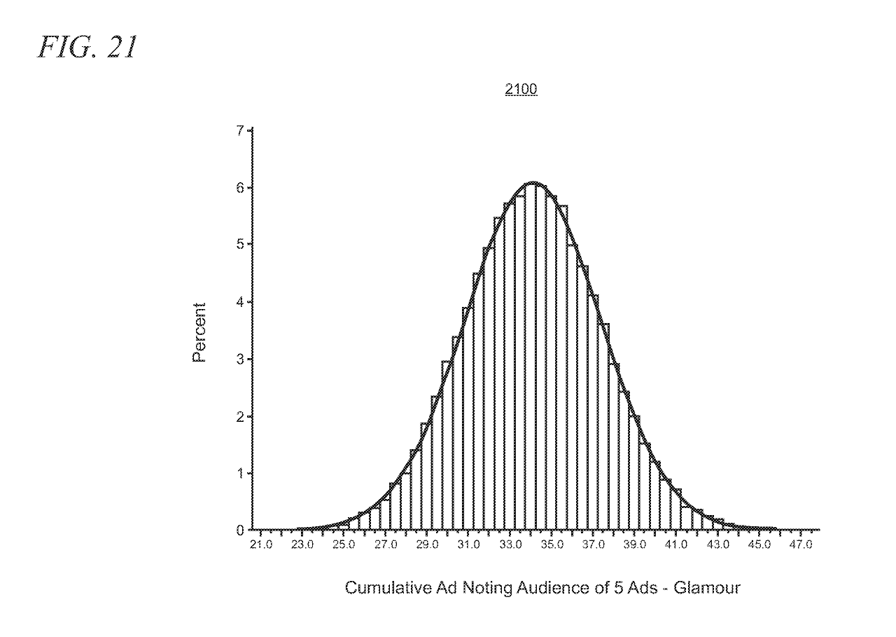

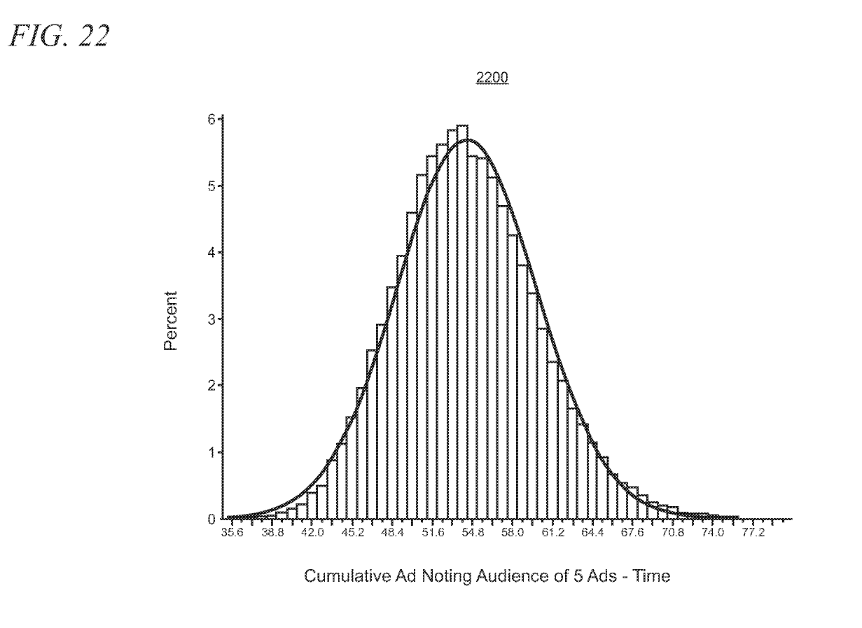

An examination of the behavior of multiple ads across multiple issues of the same magazine finds a very strong conformation for the assumption of normality. Selecting 50,000 replications, each consisting of a random sample of 5 ads from a title, histograms are then produced showing the gross ad noting audience across the 5 ads. The normal distribution is superimposed on these histograms. A conclusion from examination of the histograms 900, 1000, 1800, 1900, 2000, 2100, and 2200 respectively shown in FIGS. 9-10, and 18-22, as well as an examination of the theoretical and actual frequency distributions, is that the normality assumption is strongly supported and the resulting probabilities derived from the normal distribution will provide valid estimates of risk.

Finally, the distributions of the sum of noting audiences across multiple ads in multiple issues of different titles may be examined. This is performed by selecting 50,000 replicated samples of various numbers of ads from the two groups of titles described above. It is determined that in all the cases examined the assumption of normality is strongly supported. Two illustrative simulations are described below.

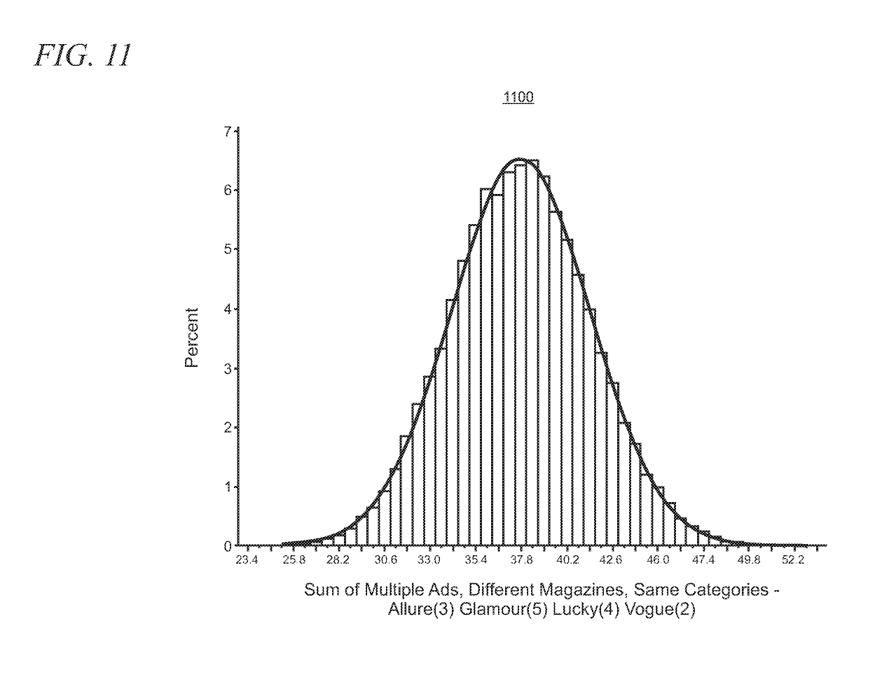

Simulation 1 consists of 50,000 repeated selections of 3 ads from Allure, 5 from Glamour, 4 from Lucky, and 2 from Vogue. The distribution of gross noting impressions is shown in the histogram 1100 shown in FIG. 11. The normal distribution function is shown by the superimposed curve. As is clear from this histogram, as well as the resulting theoretical and actual frequency counts, the assumption of normality is strongly supported. In this case, ads from the same category, Beauty and Cosmetic Aids, have been selected.

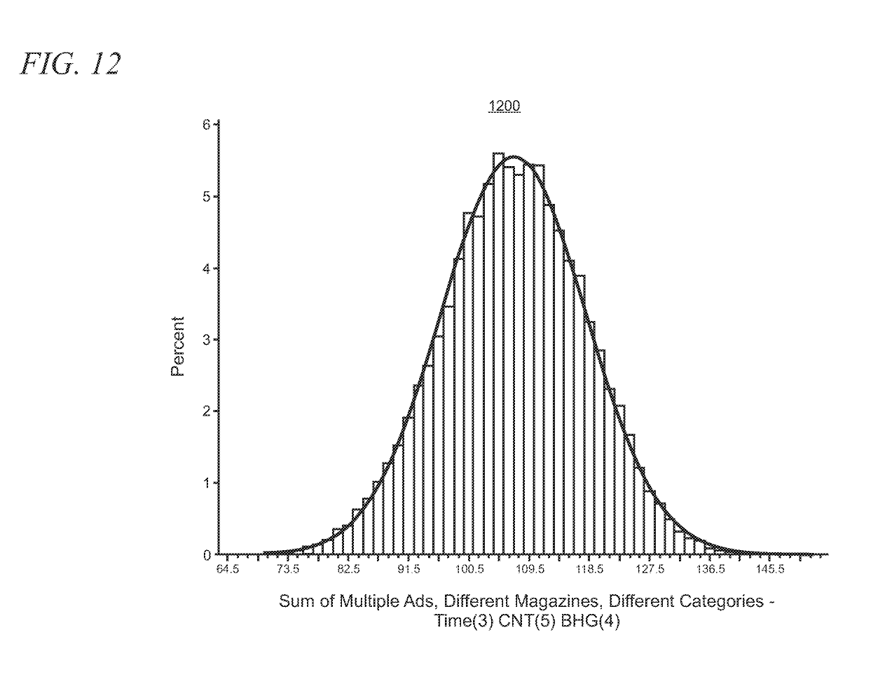

In order to examine the distribution of multiple ads in multiple magazines with different categories, a number of simulations with different titles and categories may also be performed. For example, 50,000 replications, with 3 ads selected from Time, 5 from Conde Nast Traveler, and 4 from Better Homes and Gardens, are carried out in simulation 2. The histogram 1200 with superimposed normal curve is shown in FIG. 12. As may be seen, the assumption of normality is well supported even when both titles and categories are quite different. Again, it is found that the assessment of risk based on a normal distribution is strongly justified.

In order to tailor the utility of the present risk management system to specific applications and usage scenarios, various additional features may be optionally added to the deliverable discussed above. For example, the user may be provided with a capability of assessing risk for guarantees using issue-specific audiences and “actions taken as a result of seeing an ad” projections, respectively. These features enable buyers and sellers to shift the guarantee metric to different levels in the purchasing funnel.

Another optionally utilized feature that may be desirable in some deployments of the risk management system is the capability for the buyer or seller to track the performance of ads during the campaign and to continuously evaluate whether the campaign is performing as expected based on the initial guarantee. Such a tracking system can assist sellers to adjust placement of later ads in the campaign (if there is sufficient time) or consider alternative platforms such as web sites or digital platforms to make good for a possible shortfall.

A statistical adjustment or factor that accounts for observed trends in a magazine's recent audience performance may also be optionally utilized. This feature may be useful, for example, under certain circumstances since the analytical framework herein makes use of historical data over a longer period of time. Ad noting performance(s) for surrogate magazines may also be applied to another magazine in a competitive set to establish guarantees in some cases. For example, when a given magazine has insufficient data or no history of ad noting audiences for a particular advertiser or advertising category, performance of the surrogate magazines in the same competitive set may be utilized as derived data, subject to an appropriate level of statistical analysis and testing of the derived data.

The transition from negotiating guarantees on magazine circulation to issue-specific ad noting audiences can be expected to be an ongoing process in most typical applications. Accordingly, it may be desirable to add components to the present risk management system that allow for the control of “risks” associated with over-delivery. This ability to assess both the high and low ranges in variation is often incorporated in financial product and derivative risk assessment.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A computer-implemented method for enabling a user to predict delivery of ad impressions through a user interface executing on the computer, the method comprising the steps of:
exposing a publication list from which the user may select one or more publications to be included in a calculation of a guarantee for delivery of gross ad impressions;
exposing a variably selectable time frame of historical data to the user, the historical data being utilized by the calculation;
providing a facility by which a user may search for and specify a number of ad insertions to be statistically utilized to develop the guarantee, the search based on user-selected search criteria including at least one of ad type or ad size;
exposing user-selectable options to the user through the interface, a first option enabling the user to specify a level of accepted risk for a given guarantee, and a second option enabling the user to specify a number of gross ad impressions to be guaranteed for delivery;
returning to the user an indication of a guaranteed number of delivered ad impressions associated with the specified level of risk when the user selects the first option; and
returning to the user an indication of a level of risk associated with the specified guaranteed number of delivered ad impressions when the user selects the second option.

2. The computer-implemented method of claim 1 in which the user is associated with a publisher.

3. The computer-implemented method of claim 1 in which the ad insertions are specified on a per-publication basis.

4. The computer-implemented method of claim 3 in which the publication comprises a magazine.

5. The computer-implemented method of claim 1 further including a step of enabling the user to vary the number of ad insertions and calculating a corresponding change in the guaranteed gross ad impressions.

6. One or more non-transitory computer-readable media storing instructions which, when executed, enable a computing device to implement the method of claim 1.

7. One or more non-transitory computer-readable media storing instructions which, when executed by one or more processors disposed in an electronic device, perform a method comprising the steps of:
implementing an ad guarantee tool that calculates a probability that an estimated gross audience for a user-specified set of ads in a user-specified set of publications will fall within a user-specified time interval, the assessment utilizing an historical estimate of a distribution of an issue-ad distribution and an historical estimate of issue-ad distribution variance;
supporting a user interface to the ad guarantee tool through which a user may specify the set of ads, the set of publications, and the time interval; and
using the calculated probability to return to the user either an indication of a guaranteed number of delivered gross ad impressions associated with the specified level of risk or an indication of a level of risk associated with the specified guaranteed number of delivered gross ad impressions.

8. The one or more non-transitory computer-readable media of claim 7 in which the probability is calculated according to
$$P ( {t}_{1} < S < {t}_{2} ) = {\int }_{{t}_{1}}^{{t}_{2}} \frac{1}{2 \sqrt{π {σ}_{s}^{2}}} {e}^{- {[ ( S - {μ}_{s} ) ]}^{2} / 2 {σ}_{s}^{2}} d s$$
where S=(s₁, s₂, . . . sₖ) is a given schedule of ads running in various publication issues, t₁ and t₂ bound the time interval, μᵢ is the mean of the distribution of the ith issue-ad distribution, and σᵢ² is a corresponding variance of the issue-ad distribution.

9. The one or more non-transitory computer-readable media of claim 8 in which the ad guarantee tool is implemented as a web-based application in which a client on a computing device executes instructions stored, at least in part, on a remote server.

10. The one or more non-transitory computer-readable media of claim 8 in which the guaranteed number of delivered gross ad impressions supports an ROI accountable metric.

11. The one or more non-transitory computer-readable media of claim 8 in which the ad guarantee tool is further configured for assessing associated changes in risk and reward with different gross ad impression levels.

12. The one or more non-transitory computer-readable media of claim 8 in which the ad guarantee tool is configured for providing a warning to the user if too few historical examples exist to establish a guarantee.

13. A system for determining a number of gross ad impressions that are guaranteed over the course of an ad campaign conducted over a time interval, comprising:
an input module configured for receiving from a system user a user-specified set of ads, a user-specified set of publications, and a user-specified time frame for historical data used in a guarantee calculation;
an historical data module configured for holding prior actual data that is indicative of ad noting for each publication in the user-specified set;
a statistical probability module configured for calculating a probability that an estimated gross audience for the user-specified set of ads in the user-specified set of publications will fall within the time interval; and
a reporting module configured for reporting calculation results to the user, the results including one of an indication of a guaranteed number of delivered ad impressions associated with a given level of risk or an indication of a level of risk associated with a given guaranteed number of delivered ad impressions.

14. The system of claim 13 in which the input module is further configured for receiving from the system user a number of insertions for each publication, respectively, that is included in the ad campaign.

15. The system of claim 13 in which the historical data module includes data that is indicative of a mean of the distribution of the ith issue-ad distribution and a corresponding variance of the issue-ad distribution.

16. The system of claim 13 in which the statistical probability module applies a statistical model to enable computation of levels of risk associated with various levels of audience guarantees.

17. The system of claim 15 in which the statistical model utilizes a theorem in which a sum of two independent standard normal random variables is normal with mean zero and variance two.

18. The system of claim 13 in which code stored on a remote server is executed on a client device using a web browser or mobile application.

19. The system of claim 13 in which the prior actual data comprises data obtained from media audience measurements.

20. One or more non-transitory computer-readable media storing instructions which, when executed, enable a computing device to implement the modules of claim 13.
